(19) United States
(12) Patent Application Publication
(10) Pub. No.: US 2016/0269715 A1
(43) Pub. Date: Sep. 15, 2016

(54) PARALLAX CORRECTION OF IMAGING SYSTEM

(71) Applicant: Sensors Unlimited, Inc., Princeton, NJ (US)

(72) Inventors: Michael J. Evans, Yardley, PA (US); Marc Hansen, Hamilton, NJ (US); Joshua Lund, Dallas, TX (US); Dmitry Zhilinsky, Richboro, PA (US); Michael Delamere, Pennington, NJ (US)

(73) Assignee: Sensors Unlimited, Inc., Princeton, NJ (US)

(21) Appl. No.: 14/657,641

(22) Filed: Mar. 13, 2015

(51) Int. Cl. H04N 13/02; G02B 27/22

(52) U.S. Cl. CPC H04N 13/0225; G02B 27/2214; G02B 27/225

(57) ABSTRACT

A device for capturing an image includes a first camera having a first lens optically coupled to a first image sensor of a first format. A second camera having a second lens is optically coupled to a second image sensor of a second format larger than the first format. A controller is operatively connected to the first and second cameras for selecting a sub-array of an optical image of the second image sensor to match an optical image captured by the first image sensor based on needed parallax correction between the first and second cameras.

### GOVERNMENT RIGHTS STATEMENT

This invention was made with government support under contract number HR0011-13-C-0068 awarded by Defense Advanced Research Projects Agency. The government has certain rights in the invention.

### BACKGROUND OF THE INVENTION

1. Field of the Invention

The present disclosure relates to optics, and more particularly to parallax correction such as used in imaging systems of dual cameras.

2. Description of Related Art

There are a wide variety of image detectors, such as visible light image detectors, infrared image detectors, or other types of image detectors that may be used to capture images for storage and display. Recent advances in process technology for focal plane arrays (FPAs) and image processing have led to increased capabilities and sophistication of resulting imaging systems. While these developments may provide improved features and image quality, they often negatively impact the size, weight, and power of associated systems. In particular, single aperture optical systems supporting multispectral imaging are typically complex, heavy, and expensive.

The use of a dual aperture, dual lens and dual sensor imaging systems has the added advantage of capturing different imaging details, for example infrared images at varying wavelengths. However, with the introduction of dual image sensors, there is a need for parallax correction. A variety of devices and methods are known in the art for parallax correction.

Such conventional methods and systems have generally been considered satisfactory for their intended purpose. However, there is still a need in the art for improved imaging system with dual apertures, dual lenses and dual sensors having parallax correction. The present disclosure provides a solution for this need.

### SUMMARY OF THE INVENTION

An imaging system includes a first camera having a first lens optically coupled to a first image sensor of a first format. A second camera having a second lens is optically coupled to a second image sensor of a second format larger than the first format. A controller is operatively connected to the first and second cameras for selecting a sub-array of an optical image of the second image sensor to match an optical image of the first image sensor based on needed parallax correction between the first and second cameras.

The sub-array selected can be a portion of the optical image from the second image sensor that matches the first format. The sub-array selected can match the optical image from the first image sensor by cropping the image along a top portion and a bottom portion of the optical image from the second image sensor.

The first camera can be a long wave camera. The second camera can be a short wave camera. The focus of the first lens can be fixed and focus of the second lens can be adjustable.

The first and second image sensors can remain stationary as the controller selects the sub-array. The second sensor's format can be different from that of the first.

A method of parallax correction includes a first camera having a fixed-focus lens optically coupled to a first image sensor of a first format. The method also includes focusing on the object with a second camera having a second lens optically coupled to a second image sensor of a second format containing more vertical area than the first format. A sub-array is selected of an optical image from the second image sensor to match an optical image captured by the first image sensor based on needed parallax correction for the first and second cameras.

The method can include cropping along a top portion and/or a bottom portion of the optical image from the second image sensor to match the optical image from the first image sensor such that the cropped optical image matches an aspect ratio of the first image. The method can further include merging the optical image from the first image sensor with the cropped optical image to display a parallax corrected image from the first and second cameras.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of an imaging system constructed in accordance with the present disclosure, showing first and second cameras capturing a scene and connected to a controller;

FIG. 2 is a diagrammatic view of optical images captured from the first and second cameras of FIG. 1, showing the optical image from the second camera cropped; and

FIG. 3 is a flow chart showing the method of parallax correction using the system of FIG. 1.

### DETAILED DESCRIPTION OF THE PREFERRED EMBODIMENTS

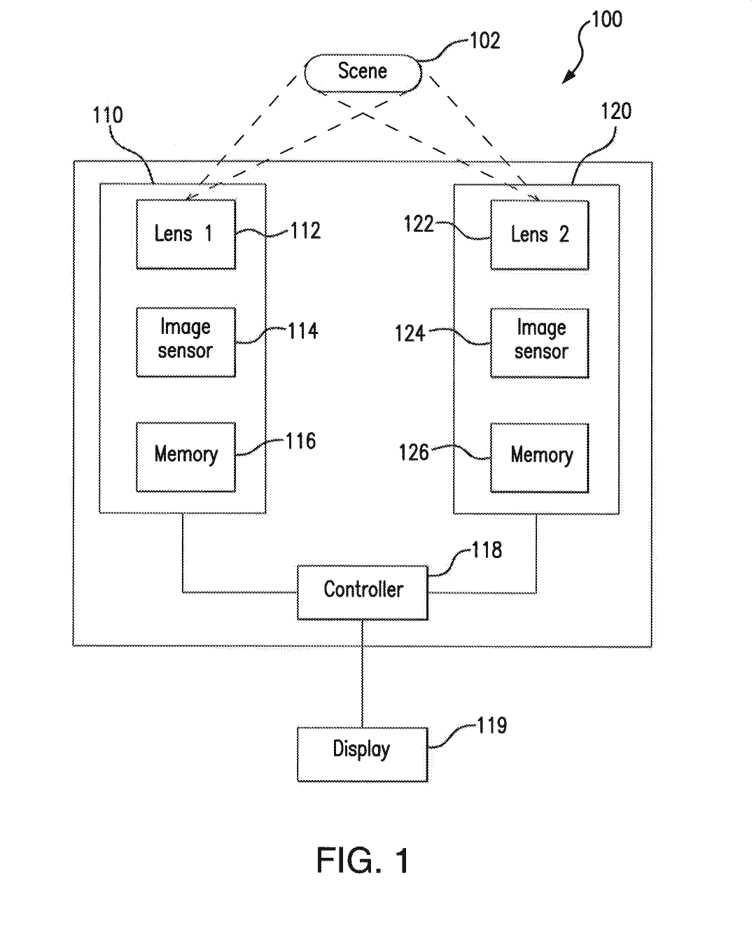

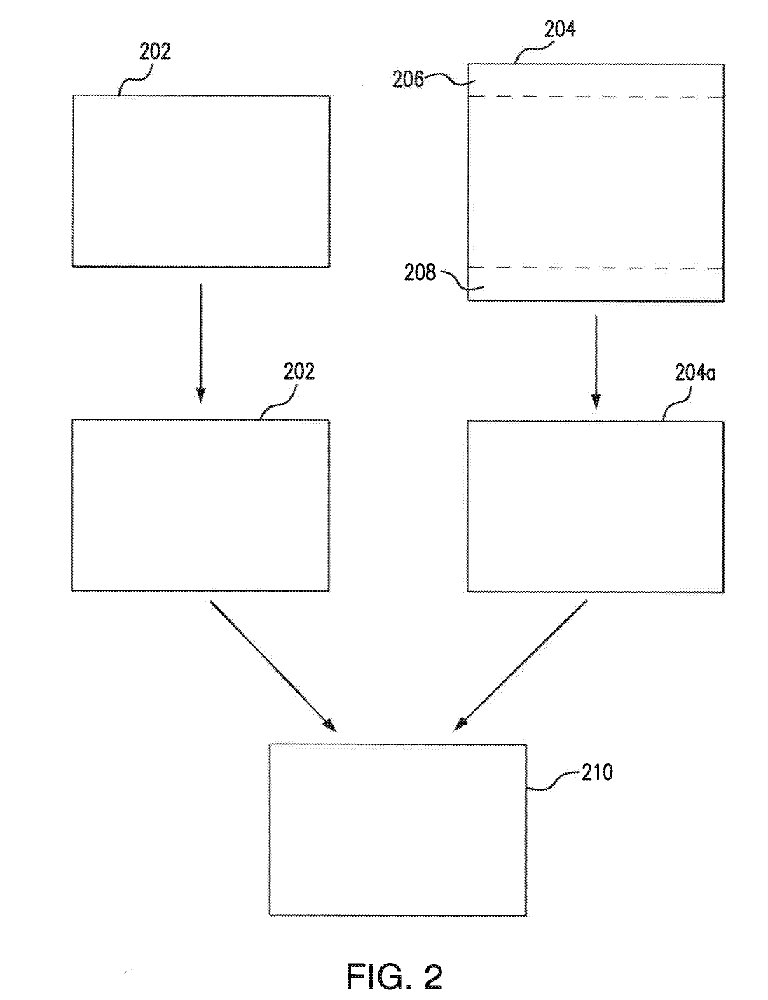

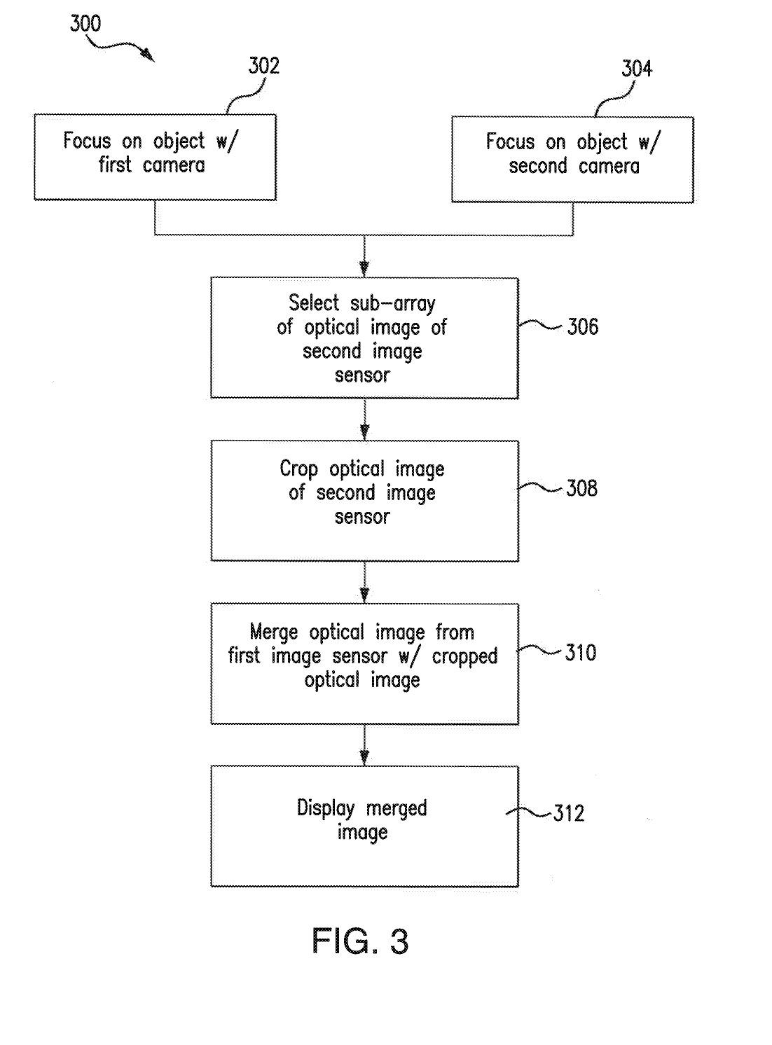

Reference will now be made to the drawings wherein like reference numerals identify similar structural features or aspects of the subject disclosure. For purposes of explanation and illustration, and not limitation, a partial view of an exemplary embodiment of an imaging system in accordance with the disclosure is shown in FIG. 1 and is designated generally by reference character 100. Other embodiments of the imaging system in accordance with the disclosure, or aspects thereof, are provided in FIGS. 2-3, as will be described.

FIG. 1 shows schematically an imaging system 100 in accordance with the present disclosure. The imaging system 100 includes at least two cameras, as shown, a first camera 110 and a second camera 120. The first and second cameras 110, 120 are directed towards a scene 102 for focusing on an object and capturing a desired image. The first camera 110 is a long wave infrared (LWIR) camera and the second camera 120 is a short wave infrared (SWIR) camera although, any suitable wavelength cameras can be used with the imaging system 100 Each of the first and second cameras 110, 120 include a lens 112, 122 optically coupled to a first and second image sensor 114, 124, respectively. The first and second image sensors 114, 124 are each in communication with a memory 116, 126 of each camera 110, 120. A controller 118 is operatively connected to the first and second cameras and is connected to a display 119.

The first image sensor 114 is of a first format having a format ratio of a typical LWIR camera. The second image sensor 124 contains additional rows of pixels and therefore is of a second format greater than the first format. In other words, the sensors' 114, 124 horizontal formats (i.e., number of columns) and pixel pitches are the same. The horizontal fields of view are the same for the first and second image sensors 114, 124, even if the number of columns is different. Since the second sensor 124 is displaced vertically from the first sensor 114, a vertical parallax is induced between the two sensors 114, 124. Because of the parallax, a given object in the scene impinges on the second sensor 124 in a spot vertically displaced from where it impinges on the first sensor 114. The degree of the displacement varies inversely with the distance of the object from the cameras 110, 120. The second sensor 124 contains additional vertical area (i.e., additional rows) such that, over the range of focus of the second camera 120, the same scene from the first sensor 114 can be captured by the second sensor 124.

In order to correct for the parallax between the first and second cameras 110, 120, an optical image 204 of the second image sensor 124 is cropped to match an optical image 202 of the first image sensor 114, as shown in FIG. 2. As the first and second cameras 110, 120 focus on the scene 102 each of the first and second image sensors 114, 124 capture a respective optical image 202, 204 with the optical image 204 of the second image sensor 124 being greater/larger than the optical image 202 of the first image sensor 114 . The optical images 202, 204 of the first and second image sensors 114, 124 are stored in the respective memories 116, 126. The controller 118, accessing the memory 116, 126 of each camera 110, 120, selects a sub-array of the optical image 204 of the second image sensor 124 that matches the optical image 202 of the first image sensor 114. More specifically, the controller 118 crops the optical image 204 of the second image sensor 124 so that the first optical image 202 and a cropped image 204a showing a portion of the second optical image 204 are of the same size. As shown in FIG. 2, the controller 118 crops a top portion 206 and a bottom portion 208 of the second optical image. The first and second imaging sensors 114, 124 remain stationary as the controller 118 selects the sub-array for the cropped image 204a. Those skilled in the art will readily appreciate that the optical image cropped in FIG. 2 is shown with an equal top and bottom portion being cropped. It will be understood that the top and bottom portions may be unequal or only a top or bottom portion may needed to be cropped to match the optical image of the first image sensor. Moreover, side portions of any other suitable portion of the optical image may be cropped for suitable applications. Since the depiction of the scene is different between LWIR and SWIR cameras, once a cropped image 204a is stored, the two images 202, 204a are merged together such that one image is displayed that illustrates a merged image having both LWIR and SWIR features.

A method 300 for parallax correction using the imaging system of FIG. 1 is shown in FIG. 3. As shown in boxes 302 and 304, a first and second camera, e.g., first camera 110 and second camera 120, are directed towards a scene to focus on an object. A controller, e.g., controller 118, selects a sub-array of an optical image, e.g. optical image 204, from a second image sensor, e.g., second image sensor 124, to match an optical image, e.g., optical image 202, captured by a first image sensor, e.g, first image sensor 114, as shown in box 306. In selecting the sub-array, the controller crops the optical image of the second image sensor along a top and/or bottom portion, as shown in box 308. Boxes 310 and 312 illustrate that after a cropped image, e.g., cropped image 204a, is created, the two images, are merged together and displayed.

The amount of cropping is determined based on distance to the object from the first and second image sensors. Any suitable technique can be used to determine the distance. This distance and the space between the two cameras can be used to determine the amount of parallax correction to apply. The amount of parallax correction, in turn, is used to determine how much cropping is required. A lookup table relating parallax to distance to object to cropping amount can be stored for use in controller 118, for example.

The methods and systems of the present disclosure, as described above and shown in the drawings, provide for an imaging system with superior properties including parallax correction between at least two cameras having different sized image sensors. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. An imaging system, the system comprising:
a first camera having a first lens optically coupled to a first image sensor of a first format;
a second camera having a second lens optically coupled to a second image sensor of a second format larger than the first format; and
a controller operatively connected to the first and second cameras for selecting a sub-array of an optical image of the second image sensor to match an optical image of the first image sensor based on needed parallax correction between the first and second cameras.

2. The system of claim 1, wherein the second format is larger than the first format because of additional rows of pixels.

3. The system of claim 1, wherein the sub-array selected is a portion of the optical image from the second image sensor that matches the first format.

4. The system of claim 1, wherein the sub-array selected matches the optical image from the first image sensor by cropping the image along a top portion and a bottom portion of the optical image from the second image sensor.

5. The system of claim 1, wherein the first camera is long wave camera.

6. The system of claim 5, wherein the second camera is short wave camera.

7. The system of claim 1, wherein a focus of first lens is fixed and a focus of the second lens is adjustable.

8. The system of claim 1, wherein the first and second image sensors remain stationary as the controller selects the sub-array.

9. A method of parallax correction, the method comprising:
focusing on an object with a first camera having a first lens optically coupled to a first image sensor of a first format;
focusing on the object with a second camera having a second lens optically coupled to a second image sensor of a second format larger than the first format; and
selecting a sub-array of an optical image from the second image sensor to match an optical image captured by the first image sensor based on needed parallax correction for the first and second cameras.

10. The method of claim 9, further comprising cropping along a top portion and a bottom portion of the optical image from the second image sensor to match the optical image from the first image sensor.

11. The method of claim 10, wherein the cropped optical image matches the first format.

12. The method of claim 10, further comprising merging the optical image from the first image sensor with the cropped optical image to display a parallax corrected image from the first and second cameras.

13. The device of claim 9, wherein the first camera is long wave camera.

14. The device of claim 13, wherein the second camera is short wave camera.
